(19) United States
(12) Patent Application Publication
(10) Pub. No.: US 2008/0048053 A1
(43) Pub. Date: Feb. 28, 2008

(54) Atomizer for atomizing fluids

(76) Inventor: Chuih-Kong Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/510,229

(22) Filed: Aug. 28, 2006

(51) Int. Cl. B05B 7/06; A62C 13/62

(52) U.S. Cl. 239/427; 239/432; 239/304; 239/303

(57) ABSTRACT

An atomizer includes a main path having an entrance and an exit. At least two sources are connected to the entrance of the main path. A plurality of chambers communicate with the main path and a narrow path communicates with each chamber and the main path. A plurality of stops extend from an inner periphery of the main path and a distal end of each stop is located corresponding to the narrow path corresponding thereto. The chambers and the stops are located between the entrance and the exit. The two different fluids flow into the entrance and are disturbed by the stops and mixed in the chambers.

### FIELD OF THE INVENTION

The present invention relates to an atomizer having a main path with a plurality of stops and chambers so as to efficiently atomize and mix at least two types of fluids.

### BACKGROUND OF THE INVENTION

Atomization is an important technique to obtain a mixture of at least two different materials with tiny particles which are used in internal combustion engine, turbines, furnaces, oil nozzles, and powder metallurgy for jet engines. The conventional ways of atomization includes pressurizing atomization, double acting atomization and rotating atomization. The pressurizing atomization uses a nozzle to accelerate the fluid at a high speed and the fluid is then atomized in a stationary or low speed air. The double acting atomization includes a path through which two different fluids are activated with each other at a high speed. The rotating atomization uses a machine to rotate the fluid by eccentric force. All of the three conventional ways cannot obtain satisfied results because the width of path for the fluids is too narrow so that the surface friction is significant for the fluids and the Reynolds number is too low so that the different fluid can not mix as desired, although the fluids are atomized.

The present invention intends to provide an atomizer which effectively mixes and atomizes different fluids in multiple stages.

### SUMMARY OF THE INVENTION

The present invention relates to an atomizer which comprises a main path having an entrance and an exit. At least two sources are connected to the entrance of the main path so as to introduce at least two fluids into the main path. A plurality of chambers communicate with the main path and a narrow path communicates with each chamber and the main path. A plurality of stops extend from an inner periphery of the main path and a distal end of each stop is located corresponding to the narrow path corresponding thereto. The chambers and the stops are located between the entrance and the exit.

The primary object of the present invention is to provide an atomizer wherein the different fluids are stirred by the stops and mixed in the chambers, the fluids are stirred and mixed many times so that the final result is satisfied.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the atomizer of the present invention;

FIG. 2 shows that the stops can be rectangular stops;

FIG. 3 shows that the chambers and the stops are located along two sides of the main path respectively;

FIG. 4 shows that the chambers are sphere-shaped chambers, and

FIG. 5 shows that a narrow path is connected in communication between the main path and the chambers.

### DETAILED DESCRIPTION OF THE PREFERRED EMBODIMENT

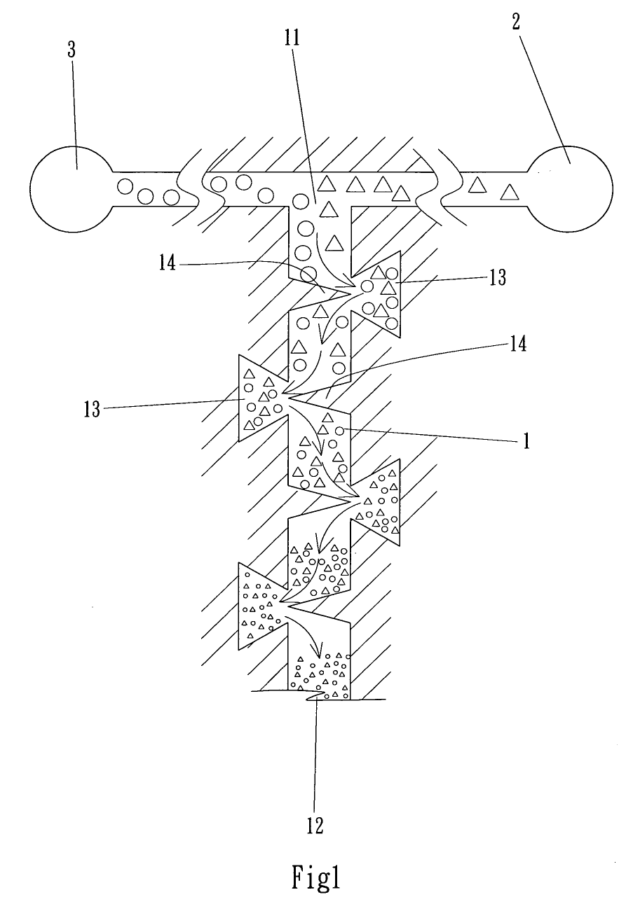

Referring to FIG. 1, the atomizer of the present invention comprises a main path 1 having an entrance 11 and an exit 12. At least two sources 2, 3 are connected to the entrance 11 of the main path 1 so as to introduce two fluids into the main path 1 at a desired speed. A nozzle (nor shown) or another atomizer (not shown) can be connected to the exit 12. A plurality of chambers 13 communicate with the main path 1 and each chamber 13 is a dove-tailed chamber. The dove-tailed chambers 13 each have a narrow path which communicates with each chamber 13 and the main path 1.

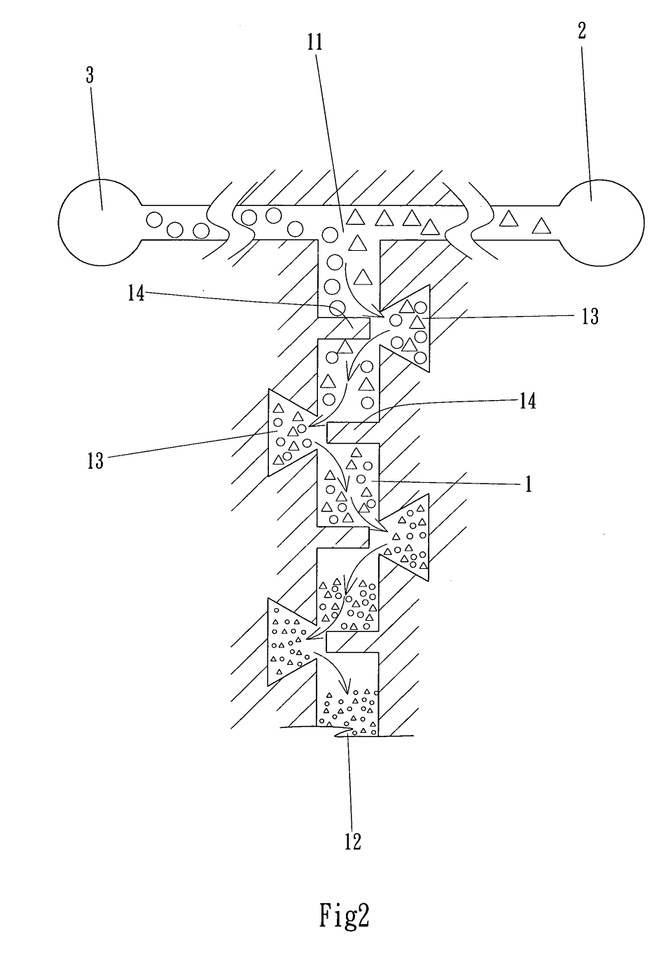

A plurality of triangular stops 14 extend from an inner periphery of the main path 1 and a distal end of each stop 14 is located corresponding to the narrow path corresponding thereto. The chambers 13 and the stops 14 are located between the entrance 11 and the exit 12. The two fluids hit the stop 14 which guide the two fluids into the chamber 13 and the two fluids are mixed in the chamber 13. The mixed fluids in the chamber 13 are than moved out from the chamber 13 and re-enter into the main path 1 by the continuously introduced fluids in the main path 1. In FIG. 1, there are four sets of chambers 13 and stops 14 disclosed so that the two fluids are mixed at least four times before the mixture goes out from the exit 12. It is noted that the particles of the fluids are formed by the impact with the stops 14 and the particles are resonated and mixed in the chambers 13 according to Holmholt resonation. FIG. 2 shows that the stops 14 each can be a rectangular stop. The chambers 13 and the stops 14 are located alternatively along each of two sides of the main path 1.

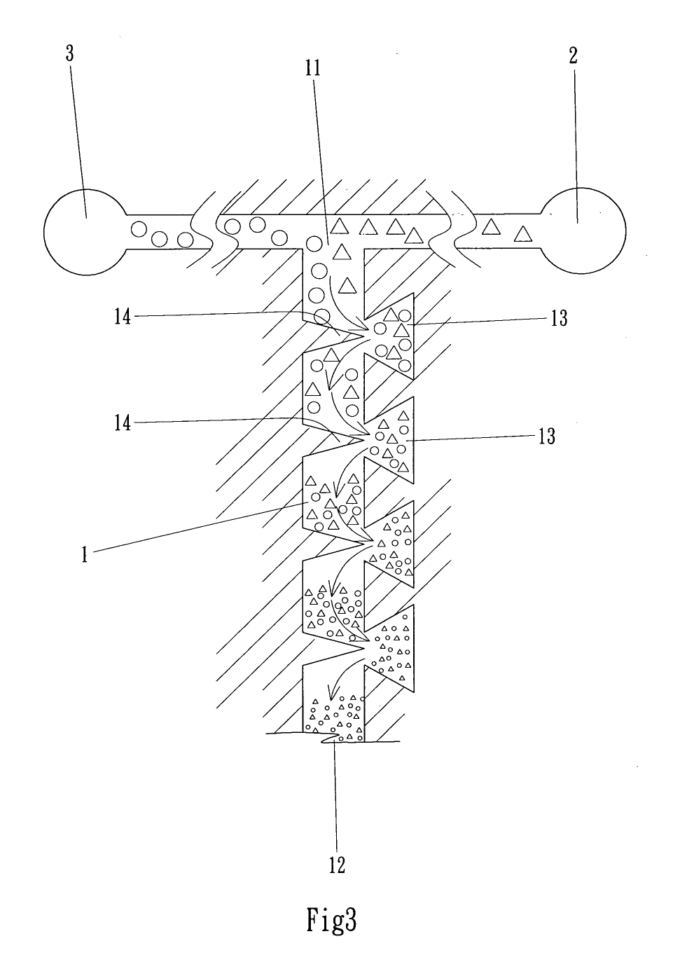

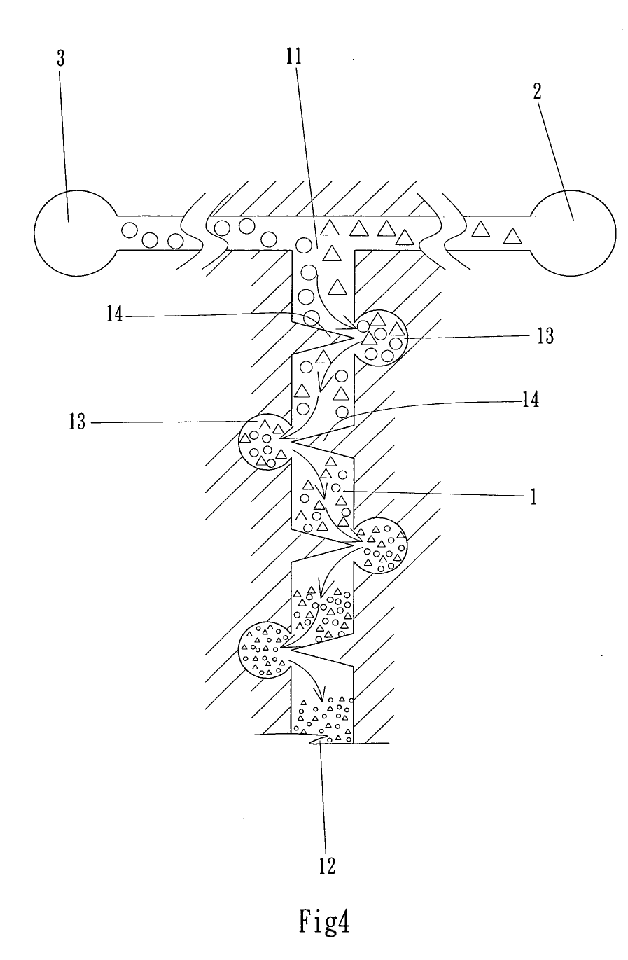

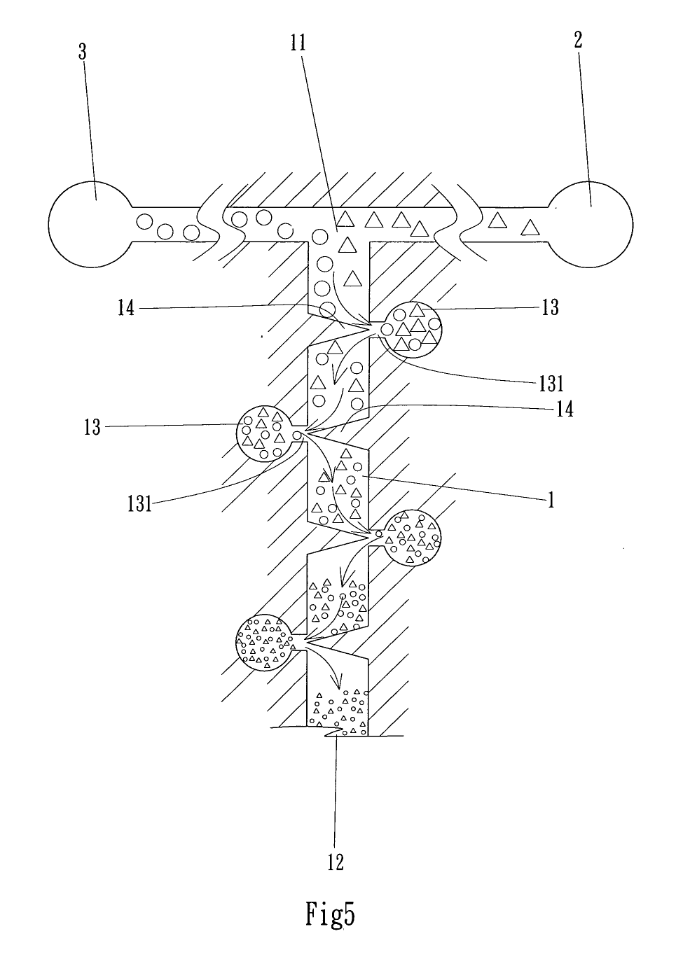

FIG. 3 shows that the chambers 13 can be located on one of two sides of the main path 1 and the stops 14 are located on the other side of the main path 1. FIG. 4 shows that the chambers 13 can be sphere-shaped chambers. FIG. 5 shows that the narrow path 131 can be a cylindrical path with an even diameter.

The fluids in the atomizer of the present invention are mixed in multiple stagers by the stops 14 and the chambers 13 so that the final result of the mixture is satisfied.

While we have shown and described the embodiment in accordance with the present invention, it should be clear to those skilled in the art that further embodiments may be made without departing from the scope of the present invention.

What is claimed is:

1. An atomizer comprising:
a main path having an entrance and an exit, at least two sources connected to the entrance of the main path, a plurality of chambers communicating with the main path and a narrow path communicating with each chamber and the main path, a plurality of stops extending from an inner periphery of the main path and a distal end of each stop located corresponding to the narrow path corresponding thereto, the chambers and the stops located between the entrance and the exit.

2. The atomizer as claimed in claim 1, wherein each of the stops is a triangular stop.

3. The atomizer as claimed in claim 1, wherein each of the stops is a rectangular stop.

4. The atomizer as claimed in claim 1, wherein the chambers and the stops are located alternatively along each of two sides of the main path.

5. The atomizer as claimed in claim 1, wherein the chambers are located on one of two sides of the main path 1 and the stops are located on the other side of the main path.

6. The atomizer as claimed in claim 1, wherein the chambers are dove-tailed chambers.

7. The atomizer as claimed in claim 1, wherein the chambers are sphere-shaped chambers.

8. The atomizer as claimed in claim 7, wherein the narrow path is a cylindrical path with an even diameter.
